(19) United States
(12) Patent Application Publication
(10) Pub. No.: US 2026/0057590 A1
(43) Pub. Date: Feb. 26, 2026

(54) METHOD AND APPARATUS FOR DISPLAYING PARTICLE ANIMATION, DEVICE, MEDIUM, AND PROGRAM PRODUCT

(71) Applicant: Tencent Technology (Shenzhen) Company Limited, Shenzhen (CN)

(72) Inventors: Mengyu ZHU, Shenzhen (CN); Xiaodong NIU, Shenzhen (CN); Guiquan ZHANG, Shenzhen (CN); Xiange HAN, Shenzhen (CN); YI ZENG, Shenzhen (CN); Tingting LI, Shenzhen (CN)

(21) Appl. No.: 19/374,833

(22) Filed: Oct. 30, 2025

Related U.S. Application Data
(63) Continuation of application No. PCT/CN2024/104728, filed on Jul. 10, 2024.

(30) Foreign Application Priority Data
Sep. 13, 2023 (CN) 202311184345.2

(51) Int. Cl. G06T 13/20; G06F 3/0482; G06F 3/04845; G06F 3/04847; G06T 19/20

(52) U.S. Cl. CPC G06T 13/20; G06F 3/04845; G06F 3/04847; G06T 19/20; G06F 3/0482; G06T 2200/24; G06T 2210/56; G06T 2219/2004; G06T 2219/2012; G06T 2219/2016

(57) ABSTRACT

This application relates to the field of animation generation, and provides a method for generating a particle animation performed by a computer device. The method includes: displaying a particle animation element in a virtual scene; displaying a parameter adjustment area corresponding to the particle animation element; receiving a parameter adjustment operation in the parameter adjustment area; and generating and playing, in the virtual scene, a particle animation corresponding to the particle animation element based on the parameter adjustment operation.

### CROSS-REFERENCE TO RELATED APPLICATIONS

This application is a continuation application of PCT Patent Application No. PCT/CN2024/104728, entitled “METHOD AND APPARATUS FOR DISPLAYING PARTICLE ANIMATION, DEVICE, MEDIUM, AND PROGRAM PRODUCT” filed on Jul. 10, 2024, which claims priority to Chinese Patent Application No. 202311184345.2, entitled “METHOD AND APPARATUS FOR DISPLAYING PARTICLE ANIMATION, DEVICE, MEDIUM, AND PROGRAM PRODUCT” filed on Sep. 13, 2023, all of which are incorporated herein by reference in their entirety.

### FIELD OF THE TECHNOLOGY

This application relates to the field of animation generation, and in particular, to a method and apparatus for displaying a particle animation, a device, a medium, and a program product.

### BACKGROUND OF THE DISCLOSURE

With the rapid development of computer technologies and diversification of terminals, electronic games are gradually widely used. In an electronic game, a virtual scene is usually displayed on a terminal, and a player may perform role activities in the virtual scene by controlling a virtual object and a virtual object controlled by another account.

In the related art, the player may freely set an animation element in the virtual scene for playback. An animation element library is displayed in the virtual scene, and the player selects an animation element from the animation element library and places the animation element into the virtual scene for display.

However, in the related art, since an animation element is a preset fixed element, to meet a selection requirement of the player, a plurality of animation elements of different styles need to be preset, thereby increasing data storage overheads of a device.

### SUMMARY

Embodiments of this application provide a method and apparatus for displaying a particle animation, a device, a medium, and a program product, so as to meet an element selection requirement of a user while reducing data storage overheads. The technical solutions are as follows.

According to an aspect, a method for generating a particle animation is performed by a computer device, the method including:
displaying a particle animation element in a virtual scene;
displaying a parameter adjustment area corresponding to the particle animation element in the virtual scene, the parameter adjustment area including a display parameter corresponding to the particle animation element;
receiving a parameter adjustment operation in the parameter adjustment area; and
generating and playing, in the virtual scene, a particle animation corresponding to the particle animation element based on the parameter adjustment operation.

According to another aspect, a computer device is provided, including a processor and a memory, the memory having at least one instruction, at least one program, a code set, or an instruction set stored therein, the at least one instruction, the at least one program, the code set, or the instruction set, when being loaded and executed by the processor, causing the computer device to implement the method for generating a particle animation according to any one of the foregoing embodiments of this application.

According to another aspect, a non-transitory computer-readable storage medium is provided, having at least one instruction, at least one program, a code set, or an instruction set stored therein, the at least one instruction, the at least one program, the code set, or the instruction set, when being loaded and executed by a processor of a computer device, causing the computer device to implement the method for generating a particle animation according to any one of the foregoing embodiments of this application.

The technical solutions provided in the embodiments of this application have at least the following beneficial effects.

When the master account has edit permission of the virtual scene, the particle animation element and the parameter adjustment area corresponding to the particle animation element are displayed in the virtual scene. After the user triggers the parameter adjustment operation in the parameter adjustment area, the computer device plays the particle animation corresponding to the particle animation element based on the parameter adjustment operation. In other words, the parameter adjustment process of the particle animation element is visualized through the parameter adjustment area, so that the user can freely adjust the display parameter of the particle animation element. On the one hand, selection requirements of different users for the particle animation can be satisfied. On the other hand, a computer can be prevented from preselecting and setting a plurality of styles of particle animation elements for storage, thereby reducing data storage overheads of a computer.

### BRIEF DESCRIPTION OF THE DRAWINGS

FIG. 1 is a schematic diagram of an implementation environment according to an exemplary embodiment of this application.

FIG. 2 is a structural block diagram of an electronic device according to an exemplary embodiment of this application.

FIG. 3 is a flowchart of a method for displaying a particle animation according to an exemplary embodiment of this application.

FIG. 4 is a flowchart of a method for displaying a particle animation according to another exemplary embodiment of this application.

FIG. 5 is a schematic diagram of a parameter adjustment area according to an exemplary embodiment of this application.

FIG. 6 is a schematic diagram of a part selection sequence according to an exemplary embodiment of this application.

FIG. 7 is a flowchart of a generation process of a key frame array according to an exemplary embodiment of this application.

FIG. 8 is a flowchart of a process of displaying a particle animation according to an exemplary embodiment of this application.

FIG. 9 is a schematic diagram of display of a particle animation after a parameter adjustment operation according to another exemplary embodiment of this application.

FIG. 10 is a schematic diagram of display of a particle animation after a parameter adjustment operation according to an exemplary embodiment of this application.

FIG. 11 is a schematic diagram of display of a particle animation after a parameter adjustment operation according to an exemplary embodiment of this application.

FIG. 12 is a flowchart of a method for displaying a particle animation according to an exemplary embodiment of this application.

FIG. 13 is a schematic diagram of a selected state box according to an exemplary embodiment of this application.

FIG. 14 is a schematic diagram of a motion adjustment area according to an exemplary embodiment of this application.

FIG. 15 is a schematic diagram of a parameter adjustment manner according to an exemplary embodiment of this application.

FIG. 16 is a schematic diagram of a parameter adjustment manner according to an exemplary embodiment of this application.

FIG. 17 is a schematic diagram of a parameter adjustment manner according to an exemplary embodiment of this application.

FIG. 18 is a schematic diagram of a parameter adjustment manner according to an exemplary embodiment of this application.

FIG. 19 is a schematic diagram of a parameter adjustment method according to an exemplary embodiment of this application.

FIG. 20 is a schematic diagram of a parameter adjustment manner according to an exemplary embodiment of this application.

FIG. 21 is a schematic diagram of superimposed display of motion unit modes according to an exemplary embodiment of this application.

FIG. 22 is a schematic diagram of a waypoint motion mode according to an exemplary embodiment of this application.

FIG. 23 is a schematic diagram of a motion parameter adjustment manner according to an exemplary embodiment of this application.

FIG. 24 is a schematic diagram of basic parameter adjustment according to an exemplary embodiment of this application.

FIG. 25 is a schematic diagram of a display mode of a particle animation according to an exemplary embodiment of this application.

FIG. 26 is a structural diagram of an apparatus for displaying a particle animation according to an exemplary embodiment of this application.

FIG. 27 is a structural diagram of an apparatus for displaying a particle animation according to another exemplary embodiment of this application.

FIG. 28 is a structural block diagram of a terminal according to another exemplary embodiment of this application.

### DESCRIPTION OF EMBODIMENTS

First, terms involved in the embodiments of this application are briefly introduced.

Virtual environment: It refer to a virtual environment displayed (or provided) when an application runs on a terminal. The virtual environment may be a simulation environment for the real world, or may be a semi-simulation and semi-fiction three-dimensional environment, and may also be a purely fictional three-dimensional environment. The virtual environment may be any one of a two-dimensional virtual environment, a 2.5-dimensional virtual environment, and a three-dimensional virtual environment. In the following embodiments, an example in which the virtual environment is the two-dimensional virtual environment is used for description. This is not limited.

Virtual object: It refers to a movable object in a virtual environment. The movable object may be a virtual piece, a virtual character, a virtual animal, a cartoon character, and the like, for example, a character, an animal, a plant, an oil barrel, a wall, and a stone displayed in the virtual environment. In some embodiments, the virtual object is a three-dimensional model created based on a skeletal animation technology. Each virtual object has a shape and a volume in the virtual environment, and occupies a part of space in the virtual environment.

User generated content (UGC): It refers to content that a user creates on the Internet and can share with another user. When the UGC is applied to a game scene, a designer encourages, by providing a UGC editing mechanism and corresponding UGC editor capabilities within a game program, the user to participate in the design of game content such as a level map, gameplay, and ecology.

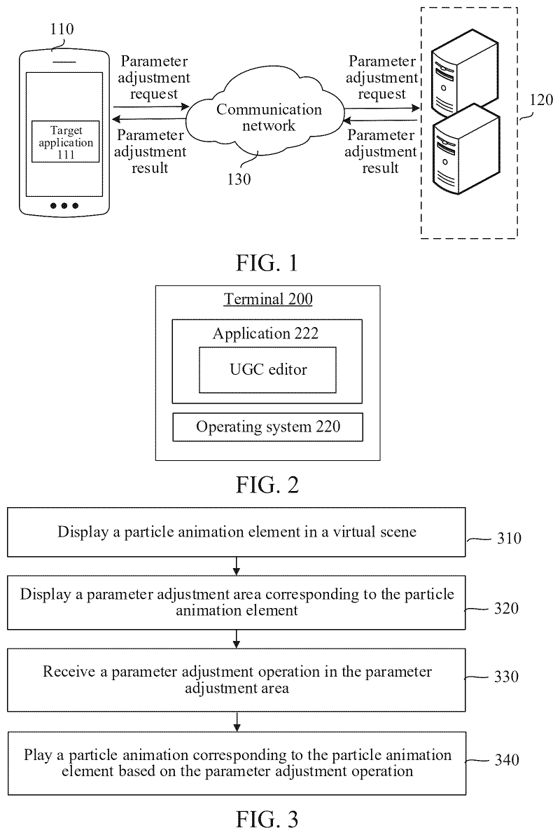

An implementation environment of this application is described. FIG. 1 is a schematic diagram of an implementation environment according to an exemplary embodiment of this application. The implementation environment includes a terminal 110, a server 120, and a communication network 130. The terminal 110 and the server 120 are connected through the communication network 130.

A target application 111 is installed and run in the terminal 110. The target application 111 is an application that supports a two-dimensional virtual environment or a three-dimensional virtual environment. The target application 111 may be any one of a virtual reality application, a three-dimensional map program, an auto chess game, a strategy game, a puzzle game, a massive multiplayer online role-playing game (MMORPG), a third-person shooting game (TPS), a first-person shooting game (FPS), a multiplayer online battle arena game (MOBA), a multiplayer shootout survival game, a sports competition game, a casual game, or sandbox games. In a possible implementation, the target application 111 may be a stand-alone application, for example, a stand-alone strategy game program, or may be an online application.

In some embodiments, when the target application 111 is implemented as a stand-alone application, the terminal displays a particle animation element in a virtual scene, and displays a parameter adjustment area corresponding to the particle animation element. When the terminal receives a parameter adjustment operation in the parameter adjustment area, a particle animation corresponding to the particle animation element is played based on the parameter adjustment operation (the foregoing situation is not shown in FIG. 1).

In some embodiments, when the target application 111 is implemented as an online application, as shown in FIG. 1, an example in which the target application 111 is implemented as a puzzle game is used. The terminal 110 displays a particle animation element in a virtual scene, and displays a parameter adjustment area corresponding to the particle animation element. The parameter adjustment area includes a plurality of display parameters corresponding to the particle animation element. When the terminal 110 receives a parameter adjustment operation in the parameter adjustment area, a parameter adjustment request is generated and transmitted to the server 120. The parameter adjustment request is configured for requesting adjustment of the display parameter of the particle animation element. After the server 120 receives the parameter adjustment request, the display parameter of the particle animation element is adjusted, so as to obtain a parameter adjustment result of the particle animation element. The parameter adjustment result is fed back to the terminal 110. The parameter adjustment result includes a plurality of adjusted display parameters corresponding to the particle animation element. After the terminal 110 receives the parameter adjustment result and then performs picture rendering on the virtual scene to display the particle animation corresponding to the particle animation element.

The foregoing terminal 110 may be a terminal device in a plurality of forms such as a desktop computer, a laptop computer, a mobile phone, a tablet computer, an e-book reader, a moving picture experts group audio layer III (MP3) player, a moving picture experts group audio layer IV (MP4) player, a smart television, and smart on-board terminal devices in a plurality of forms. This is not limited in the embodiments of this application.

The server 120 includes at least one of one server, a plurality of servers, a cloud computing platform, and a virtualization center. In some embodiments, the server 120 is in charge of primary computing work, and the terminal 110 is in charge of secondary computing work. Alternatively, the server 120 is in charge of secondary computing work, and the terminal 110 is in charge of primary computing work. Alternatively, a distributed computing architecture is used between the server 120 and the terminal 110 to perform collaborative computing.

The foregoing server may be an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a content delivery network (CDN), and a big data and artificial intelligence platform.

A cloud technology is a hosting technology that unifies a series of resources such as hardware, software, and a network in a wide area network or a local area network to implement calculation, storage, processing, and sharing of data.

In some embodiments, the server may alternatively be implemented as a node in a blockchain system.

Information (including but not limited to user device information, user personal information, and the like), data (including but not limited to data for analysis, stored data, displayed data, and the like), and signals involved in this application are all authorized by users or fully authorized by all parties, and collection, use, and processing of relevant data need to comply with relevant laws, regulations, and standards of relevant regions.

FIG. 2 is a structural block diagram showing an electronic device according to an exemplary embodiment of this application. An electronic device 200 includes an operating system 220 and an application 222.

The operating system 220 is basic software providing secure access to computer hardware for the application 222.

The application 222 is an application that supports a virtual environment. In some embodiments, the application 222 is an application that supports a three-dimensional virtual environment. The application 222 may be any one of a virtual reality application, a three-dimensional map program, an MMORPG, a TPS game, an FPS game, an MOBA game, a multiplayer shootout survival game, a social game, a puzzle game, a strategy game, a sports competition game, a casual game, or a sandbox game. The application 222 may be a stand-alone application, for example, a stand-alone game program, or may be an online application.

In this embodiment, the application 222 includes a UGC editor. The UGC editor is configured to provide a user with edit permission for a virtual scene. In some embodiments, the edit permission includes building a virtual scene, building a component displayed in the virtual scene, and setting a performance characteristic of the component (for example, a size, a color, and a special effect display effect), so that the user can control a virtual object and another virtual object to perform a scene activity in the built virtual scene, for example, an activity type such as a virtual game or level breaking. Furthermore, the virtual scene built by the user may also be shared with another user, so as to provide a virtual experience for the another user.

To be specific, a UGC editor is set in an application, so that the user can have an ability to autonomously edit a virtual scene, thereby enhancing creative enthusiasm of the user for scene editing. In this way, during the game, the user not only can have an activity experience but also have a creative experience. Moreover, the virtual scene edited and built by the user is shared with another user, so that communication between users during the game can be promoted, thereby enhancing user satisfaction, and enriching playability of the game.

Based on the above introduction, a method for displaying a particle animation provided in this application is described. The method is performed by a computer device. In some embodiments, the method may be performed by a server or a terminal, or may be jointly performed by the server and the terminal. In the embodiments of this application, a description is provided by using an example in which the method is performed by a terminal.

As shown in FIG. 3, the method includes the following operations.

Operation 310: Display a particle animation element in a virtual scene.

The virtual scene includes a master virtual object controlled by a master account, the master account having edit permission for the virtual scene, and the master virtual object being configured to be controlled to participate in a scene activity in the virtual scene.

In some embodiments, a terminal has a target application run therein. The target application is an application having a virtual scene display function. To be specific, the virtual scene is displayed during the running of the target application.

Exemplarily, particle animation elements refer to animation elements formed by a particle animation displayed in the virtual scene. The particle animation is an animation composed of motion of a large number of particles randomly generated within a certain range, and is widely used in simulating a weather system, smoke light effects, and the like. For example, when the particle animation element is a tornado, the particle animation is an animation playing a motion process of the tornado.

In some embodiments, the particle animation element is an animation element fixedly displayed in the virtual scene. To be specific, when the virtual scene is displayed, the virtual scene already includes the particle animation element. Alternatively, the particle animation element is an animation element automatically displayed in the virtual scene when a display condition of the virtual scene meets a preset display requirement. For example, when a display duration of the virtual scene reaches a preset duration threshold, the particle animation element is automatically displayed in the virtual scene. Alternatively, the particle animation element is an animation element displayed in the virtual scene based on user selection. For example, during the playback of the virtual scene, an element material library is displayed, and a user selects the particle animation element from the element material library, so that the particle animation element is displayed in the virtual scene. Alternatively, the particle animation element is an animation element generated after being designed by the user. For example, during the playback of the virtual scene, an element creation area is displayed, and the user creates the particle animation element in the element creation area, so that the particle animation element created by the user is displayed in the virtual scene.

Exemplarily, the terminal has the target application run therein, and a first account is logged in during the running of the target application. Therefore, the master virtual object is a virtual object controlled by the first account.

Exemplarily, the virtual scene is displayed on a target interface of the target application. The target interface is a building interface provided by a UGC editor in a game program run by the terminal. Exemplarily, the UGC editor is configured for custom creation of a virtual environment. A virtual component is created or edited on the building interface to implement the custom creation of the virtual environment. In the virtual environment with custom creation, a virtual character may be controlled to perform at least one of scene activities such as moving, jumping, lying, climbing, and running.

In some embodiments, the edit permission includes at least one of capabilities such as building a virtual scene, building a component in the virtual scene, and adjusting a performance characteristic of the component in the virtual scene. The component in the virtual scene is a particle animation element.

In some embodiments, the scene activity includes at least one of the activity types such as the master virtual object performing a virtual battle with another virtual object, the master virtual object performing different actions in the virtual scene, the master virtual object performing virtual social interaction with another virtual object, or the master virtual object completing a specified task with another virtual object. This is not limited in the embodiments of this application.

In some embodiments, a single particle animation element is displayed in the virtual scene, or a plurality of particle animation elements are displayed in the virtual scene.

Operation 320: Display a parameter adjustment area corresponding to the particle animation element.

The parameter adjustment area includes a plurality of display parameters corresponding to the particle animation element. In some embodiments, the foregoing plurality of display parameters may be different types of display parameters.

Exemplarily, the parameter adjustment area is an area in the virtual scene configured to adjust the display parameter of the particle animation element.

In some embodiments, the parameter adjustment area belongs to a display area in the virtual scene, or the parameter adjustment area is a display area superimposed on a scene picture corresponding to the virtual scene.

In some embodiments, the parameter adjustment area of the particle animation element is displayed during the editing of the virtual scene by the master account, or the parameter adjustment area of the particle animation element is displayed during the control of the master virtual object to perform a virtual activity by the master account.

In some embodiments, a display mode of the parameter adjustment area includes at least one of the following manners. 1. When the user selects a particle animation element for adjustment of the display parameter in the virtual scene, the parameter adjustment area is displayed. 2. An element selection library area is displayed in the virtual scene. When the user drags the particle animation element from the element selection library area into the virtual scene for display, the element selection library area is switched to the parameter adjustment area for display. 3. A parameter adjustment control is displayed in the virtual scene. After the parameter adjustment control is received, the parameter adjustment area is displayed. The foregoing display mode of the parameter adjustment area is merely an illustrative example, which is not limited in this embodiment of this application.

In an implementable case, when a plurality of particle animation elements are displayed in the virtual scene, the parameter adjustment area corresponding to each of the plurality of particle animation elements is displayed in the virtual scene. Alternatively, when a plurality of particle animation elements are displayed in the virtual scene, only the parameter adjustment area corresponding to one of the particle animation elements is displayed in the virtual scene. As a selection operation on a specified particle animation element is received, the parameter adjustment area is switched to the parameter adjustment area corresponding to the specified particle animation element.

In some embodiments, the parameter adjustment area is a parameter adjustment area corresponding to a randomly selected particle animation element, or the parameter adjustment area is the parameter adjustment area corresponding to the specified particle animation element selected by the user.

In some embodiments, the display parameter includes at least one of an appearance type parameter and a motion mode parameter. The appearance type parameter refers to an appearance of a particle animation element displayed in the virtual scene, including at least one of the performance characteristic types such as a color, a size, a direction, and transparency. The motion mode parameter refers to at least one of parameter types such as a position, a movement velocity, a movement direction, a rotation direction, a rotation velocity, a display starting position, a display ending position, a dwell position during the display, and a movement angular velocity of the particle animation element displayed in the virtual scene.

Operation 330: Receive a parameter adjustment operation in the parameter adjustment area.

Exemplarily, the parameter adjustment operation is configured for indicating adjustment of the display parameter of the particle animation element in a picture of the virtual scene. To be specific, the parameter adjustment operation refers to an operation of adjusting the display parameter of the particle animation element.

In some embodiments, the particle animation element correspondingly has an initial display parameter during the display in the virtual scene, and adjusting the initial display parameter is used as the parameter adjustment operation. In some embodiments, a parameter input operation of inputting a plurality of display parameters is received from the parameter adjustment area is used as the parameter adjustment operation. In some embodiments, the parameter adjustment operation is performed on only a single particle animation element at a time, or the parameter adjustment operation may be performed on a plurality of particle animation elements simultaneously at a time.

In some embodiments, the operation manner of the parameter adjustment operation includes at least one of the following operation manners. 1. Inputting a parameter value into the parameter adjustment area is used as the parameter adjustment operation. 2. A candidate parameter option is displayed in the parameter adjustment area, and a selection operation on a target parameter option is received as the parameter adjustment operation. 3. Adjusting a parameter through voice input is used as the parameter adjustment operation. The foregoing operation manner of the parameter adjustment operation is merely an illustrative example, which is not limited in the embodiments of this application.

Operation 340: Play a particle animation corresponding to the particle animation element based on the parameter adjustment operation.

Exemplarily, a target display parameter of the particle animation element is determined through the parameter adjustment operation, so as to display the particle animation of the particle animation element in the virtual scene based on the target display parameter.

In some embodiments, the particle animation is an animation generated by continuously playing a plurality of video frames corresponding to the particle animation element.

In some embodiments, an operation quantity of the parameter adjustment operations is 1, and therefore the particle animation is directly played based on the target display parameter corresponding to the parameter adjustment operation. Alternatively, when a plurality of parameter adjustment operations are included, the particle animation is played based on an operation order of the parameter adjustment operations.

Based on the above, according to the method for displaying a particle animation provided in the embodiments of this application, when the master account has edit permission of the virtual scene, the particle animation element and the parameter adjustment area corresponding to the particle animation element are displayed in the virtual scene. After the user triggers the parameter adjustment operation in the parameter adjustment area, the computer device plays the particle animation corresponding to the particle animation element based on the parameter adjustment operation. In other words, the parameter adjustment process of the particle animation element is visualized through the parameter adjustment area, so that the user can freely adjust the display parameter of the particle animation element. On the one hand, selection requirements of different users for the particle animation can be satisfied. On the other hand, a computer can be prevented from preselecting and setting a plurality of styles of particle animation elements for storage, thereby reducing data storage overheads of a computer.

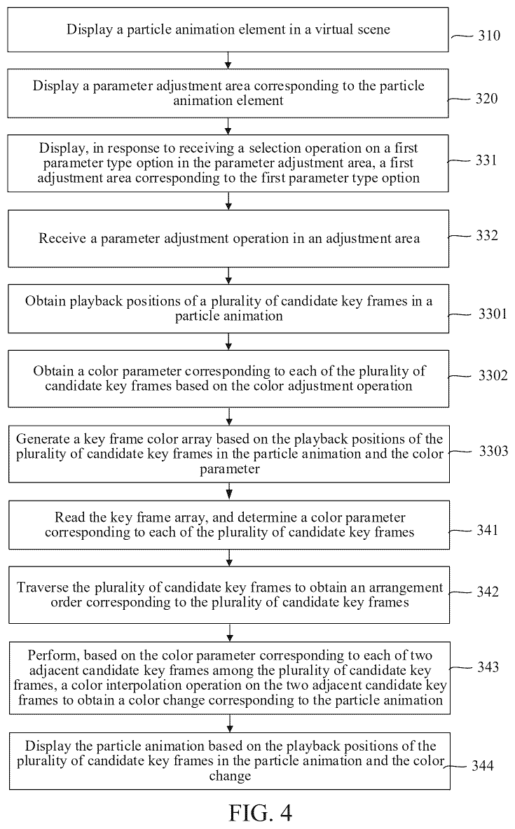

In some embodiments, the parameter adjustment operation for the appearance type parameter is described in detail. Exemplarily, FIG. 4 shows a method for displaying a particle animation according to an exemplary embodiment of this application. To be specific, operation 330 further includes operation 331 to operation 332, operation 330 further includes operation 3301 to operation 3303, and operation 340 further includes operation 341 to operation 344. As shown in FIG. 4, the method includes the following operations.

Operation 331: Display, in response to receiving a selection operation on a parameter type option in the parameter adjustment area, an adjustment area corresponding to the parameter type option.

The adjustment area includes a plurality of adjustment parameter contents under the parameter type option.

In some embodiments, the parameter adjustment area includes a plurality of parameter type options. Exemplarily, the parameter type option includes three types of options: a basic type option, an appearance type option, and a motion type option. The basic type option includes basic parameters such as an element size, a movement distance, a rotation direction, and a scaling ratio of the particle animation element. The appearance type option includes appearance parameters such as a color, a quantity of key frames in the particle animation, and a key frame position. The motion type option includes motion parameters such as a motion mode within a single unit, a motion cycle mode, a motion start moment, a motion end moment, a motion starting position, a motion ending position, a motion mode, a dwell position during the motion, a motion delay time, and a velocity type.

Exemplarily, when a selection operation on a parameter type option is received in the parameter adjustment area, an adjustment area corresponding to the parameter type option is displayed. The adjustment area is an adjustment sub-area corresponding to the parameter type option in the parameter adjustment area.

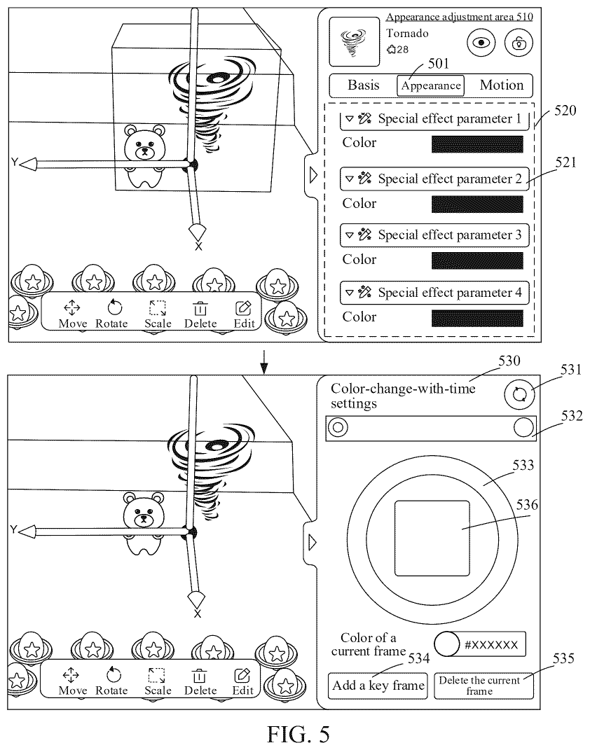

In this embodiment, when a selection operation on the appearance type option is received in the parameter adjustment area, an appearance adjustment area corresponding to the appearance type option is displayed. Exemplarily, FIG. 5 is a schematic diagram of a parameter adjustment area according to an exemplary embodiment of this application. As shown in FIG. 5, when the parameter adjustment area is currently displayed and a selection operation on an appearance type option 501 is received in the parameter adjustment area, an appearance adjustment area 510 is displayed.

In this embodiment, a parameter type option is provided to a user, so that the user can select different type options to implement parameter adjustment, and the user can more easily find a parameter that needs to be adjusted, thereby improving implementation efficiency of the parameter adjustment operation and improving user experience.

Operation 332: Receive a parameter adjustment operation in an adjustment area.

Exemplarily, the parameter type option includes an appearance type option, the adjustment area includes an appearance adjustment area, the appearance adjustment area includes a plurality of candidate position options, and each of the candidate position options is configured for indicating an element display part of a particle animation element during the display.

In this embodiment, a description is provided by using an example in which the parameter type option is implemented as the appearance type option, and the adjustment area is implemented as the appearance adjustment area.

Exemplarily, the candidate position option refers to the element display part corresponding to the particle animation element during playback of a particle animation, for example, an upper part, a middle part, and a lower part of the element. For another example, the particle animation element is displayed in layers, including a first layer, a second layer, a third layer, and a fourth layer.

Exemplarily, as shown in FIG. 5, a plurality of candidate position options 520 are displayed in the appearance adjustment area 510. A special effect parameter 1 represents a position option corresponding to an element display part 1.

In some embodiments, an adjustment sub-area corresponding to the first position option is displayed in response to receiving a selection operation on a first position option among the plurality of candidate position options in the appearance adjustment area, the adjustment sub-area including a plurality of parameter content options. An adjustment operation on the parameter content option is received in the adjustment sub-area as the parameter adjustment operation. The first position option corresponds to a first display part, the first display part corresponding to a first color.

Exemplarily, when a selection operation on the first position option is received in the appearance adjustment area, the adjustment sub-area corresponding to the first position option is displayed. The adjustment sub-area is configured to perform parameter adjustment on the first display part of the particle animation element.

Exemplarily, the plurality of parameter content options correspond to different types of parameter types. An adjustment operation performed on a target parameter content option is received in the adjustment sub-area as the parameter adjustment operation.

Exemplarily, as shown in FIG. 5, when a selection operation performed on a first position option 521 is received in the appearance adjustment area 510, an adjustment sub-area 530 of the first position option 521 is displayed.

In this embodiment, the adjustment sub-area 530 includes a reset function option 531, a color-change-with-time bar option 532, a color adjustment function option 533, a key frame addition option 534, and a current frame deletion option 535. The reset function option 531 is configured to reset the color of the first display part after being triggered, and restore the preset initial color. The color-change-with-time bar option 532 refers to a key frame (represented by a circle) corresponding to the particle animation element within an animation playback cycle. The particle animation is composed of a plurality of video frames that are continuously played. The plurality of video frames include a start frame identifier (a video frame on the far left), an end frame identifier (a video frame on the far right), and a key frame identifier. The start frame, the end frame, and the key frame are configured to control a color change of the particle animation element. To be specific, at the frame, a color change may be displayed at the first display part of the particle animation element. The start frame and the end frame cannot be moved or deleted. The start frame and the end frame also belong to the key frame. A key frame may be added between the start frame and the end frame through the key frame addition option 534 and the current frame deletion option 535, and the key frame may also be deleted. In other words, if the key frame addition option 534 is triggered, a circle identifier is added to the color-change-with-time bar option 532, indicating that a key frame is added. The color adjustment function option 533 is configured for adjusting a color of the first display part.

In this embodiment, a playback duration between the start frame and the end frame may be referred to as a “life cycle” of the particle animation.

In some embodiments, in response to receiving a selection operation on a first key frame in the adjustment sub-area, a color adjustment sub-interface corresponding to the first key frame is displayed, the first key frame being configured for indicating a display moment of a first display part of the particle animation element during playback of the particle animation.

Exemplarily, a selection operation on the first key frame among a plurality of key frames is firstly received on the adjustment sub-interface, and the first key frame on which color adjustment needs to be performed is determined, so that the color adjustment sub-interface corresponding to the first key frame is displayed on the adjustment sub-interface, a color adjustment result corresponding to the first key frame being displayed on the color adjustment sub-interface.

As shown in FIG. 5, when a selection operation on the start frame identifier (the video frame on the far left) is received in the adjustment sub-area 530, the color adjustment function option 533 corresponding to the start frame is updated and displayed as the color adjustment sub-interface. The color adjustment function option 533 is implemented as a color palette, and a color adjustment position point 536 is displayed in the color palette and is configured to indicate a color currently corresponding to the start frame. If a selection operation on another key frame is received, the color adjustment position point 536 changes accordingly, and the changed position corresponds to the color of the another key frame.

In some embodiments, a color adjustment operation is received in the color adjustment sub-interface as the parameter adjustment operation, the color adjustment operation being configured for indicating adjustment of the first color corresponding to the first display part to a second color at the first key frame.

Exemplarily, after the first key frame is currently selected, the first display part corresponding to the first key frame presents the first color, and the color adjustment operation is to adjust the first color to the second color through the color adjustment function option.

As shown in FIG. 5, the color adjustment position point 536 is moved to change the color corresponding to the first key frame, so that the first color corresponding to the first key frame is adjusted to the second color.

In some embodiments, in response to receiving a key frame addition operation in the adjustment sub-area, a color adjustment sub-interface corresponding to a second key frame is displayed, the key frame addition operation being configured for indicating addition of the second key frame.

Exemplarily, the key frame addition option is triggered on the adjustment sub-interface, so that the second key frame can be added between the start frame and the end frame, as shown in FIG. 5, when a trigger operation on the key frame addition option 534 is received. A key frame identifier corresponding to the second key frame is added and displayed at any position between the start frame identifier and the end frame identifier in the color-change-with-time bar option 532, and a movement operation may be performed on a key frame identifier corresponding to the second key frame to adjust a position of the second key frame between the start frame and the end frame, thereby controlling the display moment of the second key frame in the particle animation. For example, when the second key frame is translated leftward, it indicates that the display moment of the second key frame in the particle animation is advanced, and when the second key frame is translated rightward, it indicates that the display moment of the second key frame in the particle animation is delayed. In this embodiment, five key frames (including the start frame and the end frame) can be added to a single particle animation element at most.

In this embodiment, in a progress bar whose color changes over time, a plurality of key frames may be added (or deleted) between the start frame and the end frame, and the color corresponding to each of the key frames may be independently adjusted, so that the final particle animation element has a plurality of color changes during the playback of the particle animation. A larger quantity of key frames indicates higher richness of the color changes. In other words, the user not only can adjust a color parameter of the entire particle animation element, but also can adjust the color parameter for the particle animation element at a certain moment during the playback of the particle animation, thereby enriching the adjustment manner of parameter adjustment for the particle animation element by the user.

In some embodiments, since the particle animation element includes a plurality of element display parts, parameter adjustment is performed based on different element display parts during the parameter adjustment operation. Therefore, a part selection sequence is displayed in the appearance adjustment area based on a selection order corresponding to the selection operation on the first position option, which is configured for indicating an order in which the user performs parameter adjustment on a plurality of element display parts during the entire parameter adjustment operation. In this embodiment, when the particle animation element includes a plurality of element display parts, only the first element display part is adjusted, or a plurality of element display parts may be adjusted.

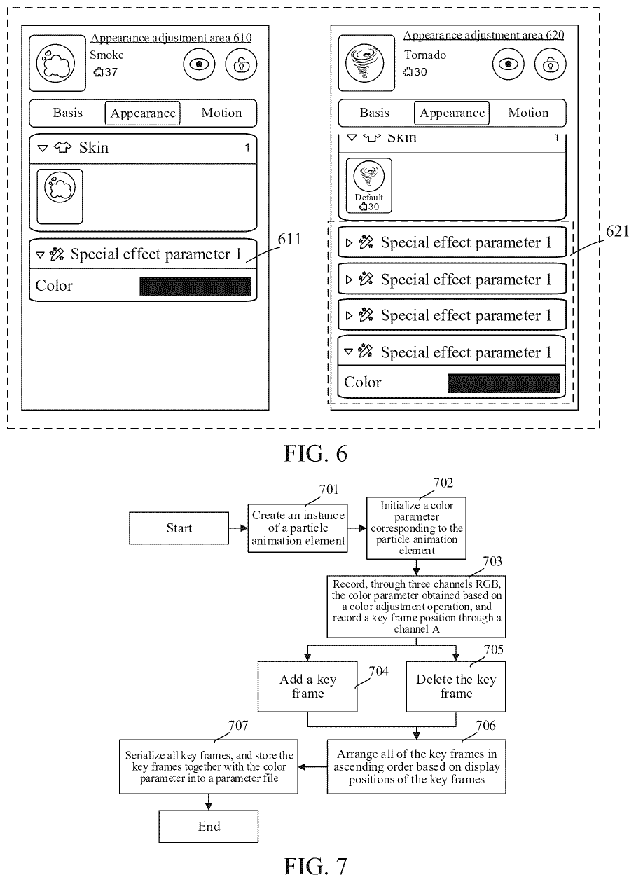

Exemplarily, FIG. 6 is a schematic diagram of a part selection sequence according to an exemplary embodiment of this application. As shown in FIG. 6, an appearance adjustment area 610 corresponding to a smoke animation element, and an appearance adjustment area 620 corresponding to a tornado animation element are currently displayed. The appearance adjustment area 610 includes a position option 611 corresponding to a single element display part for performing a parameter adjustment operation, and the appearance adjustment area 620 includes a position option 621 corresponding to a plurality of element display parts for performing a parameter adjustment operation.

In some embodiments, a quantity of element display parts is preset and fixed, or the quantity of element display parts may be determined by a user.

In some embodiments, a template generation operation is received. The template operation is configured for generating a display template based on the adjusted display parameter, and displaying, in response to receiving a selection operation on a first animation element, the first animation element in the virtual scene based on the display template, the first animation element being different from a particle animation element.

In this embodiment, after the adjustment of the display parameter is completed, the adjusted display parameter is stored through the template generation operation, so as to obtain a display template corresponding to the adjusted display parameter. Therefore, after the first animation element is selected subsequently, the first animation element may be automatically displayed based on the adjusted display parameter without needing to adjust the display parameter corresponding to the animation element again, thereby improving parameter adjustment efficiency.

Operation 3301: Obtain playback positions of a plurality of candidate key frames in the particle animation.

Exemplarily, the adjustment sub-area includes a plurality of candidate key frames. The plurality of candidate key frames corresponding to the particle animation element are determined through the parameter adjustment operation, and display positions of the plurality of candidate key frames during the playback are determined based on the particle animation. An alpha (a channel A) in four channels RGBA is configured to store the display positions of the plurality of candidate key frames during the playback.

Operation 3302: Obtain a color parameter corresponding to each of the plurality of candidate key frames based on the color adjustment operation.

In this embodiment, the color parameter corresponding to each of the plurality of candidate key frames is determined based on the color adjustment operation in the parameter adjustment operation. Three channels RGB in the four color channels RGBA are configured to store the color parameter, where an R channel represents a red channel, a G channel represents a green channel, and a B channel represents a blue channel. Therefore, the channel A needs to perform mutual conversion on integers between 0 and 255 and floating-point numbers between 0 and 1.

Operation 3303: Generate a key frame color array based on the playback positions of the plurality of candidate key frames in the particle animation and the color parameter.

In this embodiment, the display positions of the plurality of candidate key frames during the playback of the particle animation are ordered to obtain key frame ordering results. After the key frame ordering results are serialized, a key frame sequence is generated. A key frame color array is generated through the key frame sequence and the color parameter and stored in a parameter file corresponding to the particle animation element.

Exemplarily, FIG. 7 is a flowchart of a generation process of a key frame array according to an exemplary embodiment of this application. As shown in FIG. 7, a particle animation element instance 701 is first created, and a color parameter 702 corresponding to a particle animation element is initialized. Initialization refers to setting a color corresponding to a start frame and a color corresponding to an end frame of the particle animation element, and the color parameters corresponding to the element display parts in the particle animation element are the same (or may be different). Next, the color parameters obtained based on the color adjustment operation are recorded through three channels RGB, and a key frame position 703 is recorded through a channel A. In some embodiments, a key frame 704 may be added to the particle animation element or a key frame 705 may be deleted therefrom, so that all of the key frames are arranged in ascending order based on display positions of key frames 706, and then all of the key frames are serialized and stored together with the color parameters into a parameter file 707. The serialized key frame and the color parameter are used as a key frame color array.

Operation 341: Read the key frame color array, and determine a color parameter corresponding to each of the plurality of candidate key frames.

Exemplarily, during playback of a particle animation, the key frame color array is first read, and the color parameter in the key frame color array is deserialized onto the particle animation element, thereby obtaining the color parameter corresponding to the particle animation element at each of the plurality of candidate key frames.

Operation 342: Traverse the plurality of candidate key frames to obtain an arrangement order corresponding to the plurality of candidate key frames.

In this embodiment, a current key frame array corresponding to the particle animation is created. For the current key frame array, the plurality of candidate key frames included in the key frame array are traversed to determine the arrangement order of the plurality of candidate key frames in the particle animation.

Operation 343: Perform, based on the color parameter corresponding to each of two adjacent candidate key frames among the plurality of candidate key frames, a color interpolation operation on the two adjacent candidate key frames to obtain a color change corresponding to the particle animation.

In this embodiment, after the color parameter corresponding to each of the plurality of candidate key frames is determined, for an i^{th} video frame corresponding to the current particle animation, two adjacent candidate key frames corresponding to the i^{th} video frame are obtained, and a color interpolation operation is performed on a color parameter corresponding to each of the two video frames, thereby obtaining a color parameter corresponding to the i^{th} video frame, and finally obtaining the color parameter corresponding to each of all of the video frames in the particle animation as the color change corresponding to the particle animation.

The color interpolation operation refers to calculating a color parameter corresponding to a video frame between two candidate key frames based on the color parameter corresponding to each of the two candidate key frames, thereby implementing a color transition between the two candidate key frames. For example, if a key frame 1 is set to red and a key frame 2 is set to blue, a color gradient from red to blue is presented from the key frame 1 to the key frame 2, thereby calculating the color parameters corresponding to the video frames during the color gradient. Through the color interpolation operation, the particle animation can be presented in a representation form of a color gradient during the color change, so that the displayed color change is not abrupt and the particle animation has a better presentation effect.

Operation 344: Display the particle animation based on the playback positions of the plurality of candidate key frames in the particle animation and the color change.

During the playback of the particle animation, a completion time corresponding to a target key frame is determined based on a time relationship between a current moment and an adjacent target key frame moment thereof, thereby displaying the particle animation. If the current moment is less than the target key frame moment, it indicates that the target key frame has not yet been completed. If the current moment is greater than the target key frame moment, it indicates that the target key frame has been completed, and a next candidate key frame is used as the target key frame.

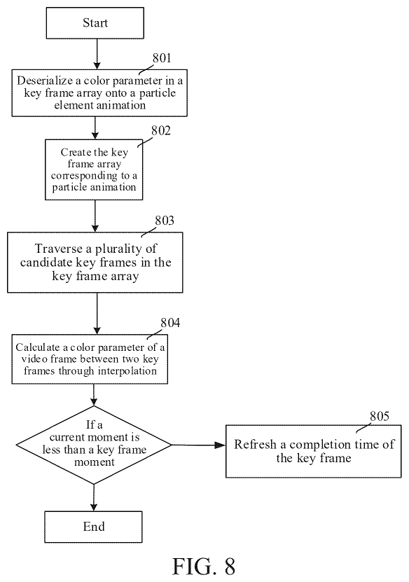

Exemplarily, FIG. 8 is a flowchart of a display process of a particle animation according to an exemplary embodiment of this application. As shown in FIG. 8, first, a color parameter in a key frame array is deserialized onto a particle element animation 801. A key frame array 802 corresponding to the particle animation is created. A plurality of candidate key frames 803 are traversed in the key frame array. A color parameter 804 of a video frame between two key frames is calculated through interpolation. If a current moment is greater than a display moment of a target key frame, a completion time 805 of the key frame is refreshed, and if the current moment is less than the display moment of the target key frame, the playback ends.

Exemplarily, parameter adjustment operations for three different appearance type parameters is described below.

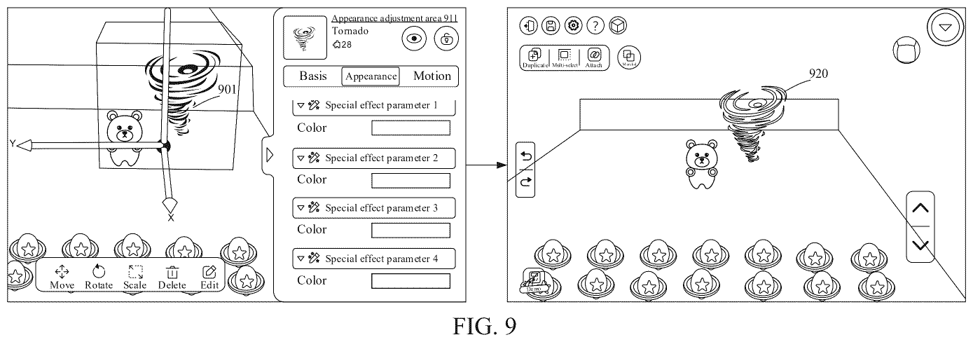

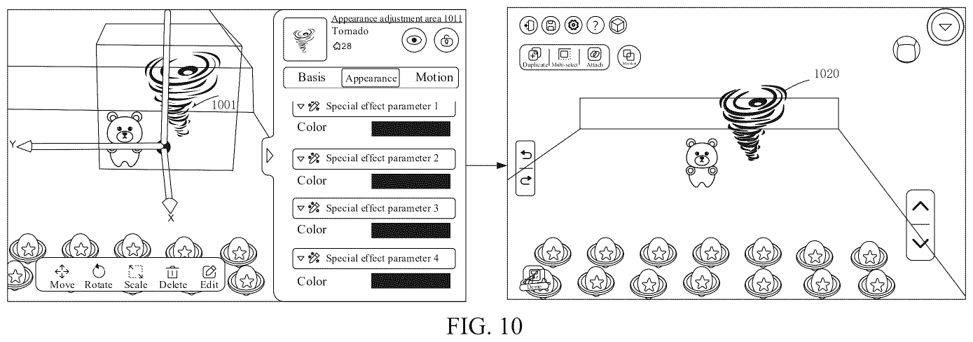

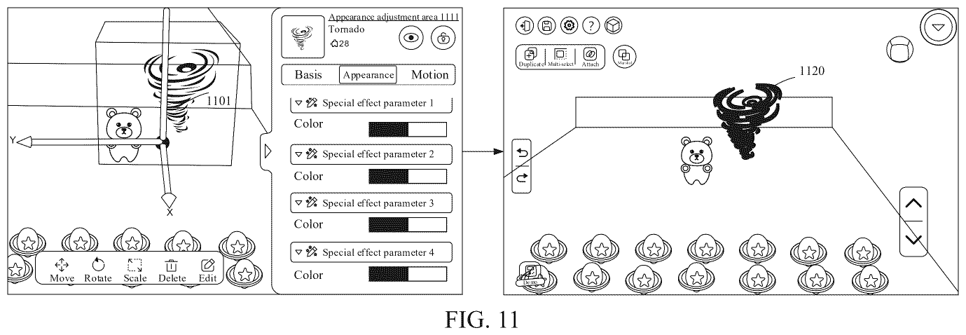

Exemplarily, FIG. 9, FIG. 10, and FIG. 11 are schematic diagrams showing display of a particle animation after a parameter adjustment operation is performed according to an exemplary embodiment of this application. As shown in FIG. 9, an appearance adjustment area 911 and a particle animation element 901 in a virtual scene are currently displayed. After the parameter adjustment operation is performed in the appearance adjustment area 911, a particle animation 920 is displayed in the virtual scene. An appearance of the particle animation 920 is different from an appearance of the particle animation element 901.

As shown in FIG. 10, an appearance adjustment area 1011 and a particle animation element 1001 in a virtual scene are currently displayed. After the parameter adjustment operation is performed in the appearance adjustment area 1011, a particle animation 1020 is displayed in the virtual scene. An appearance of the particle animation 1020 is different from an appearance of the particle animation element 1001.

As shown in FIG. 11, an appearance adjustment area 1111 and a particle animation element 1101 in a virtual scene are currently displayed. After the parameter adjustment operation is performed in the appearance adjustment area 1111, a particle animation 1120 is displayed in the virtual scene. An appearance of the particle animation 1120 is different from an appearance of the particle animation element 1101.

In some embodiments, a parameter introduction area in an element position corresponding to the particle animation element is displayed in response to receiving a long-press operation on the particle animation element in the virtual scene, and an operation duration reaching a preset duration threshold, the parameter introduction area including the adjusted display parameter. The element position is configured for indicating a position associated with the particle animation element. In some embodiments, the foregoing element position may be a position around the particle animation element, for example, above, below, on the left, or on the right. Alternatively, the foregoing element position may be a position suspended at the position of the particle animation element.

In this embodiment, during the display of the particle animation corresponding to the particle animation element in the virtual scene, when a long-press operation on the particle animation element is received and the operation duration meets the preset duration threshold, the parameter introduction area corresponding to the particle animation element is displayed above the particle animation element, so as to show the current adjusted display parameter corresponding to the particle animation element to a player, so that another player can conveniently obtain the parameter information corresponding to the particle animation element, thereby improving information interoperability.

Based on the above, according to the method for displaying a particle animation provided in the embodiments of this application, when the master account has edit permission of the virtual scene, the particle animation element and the parameter adjustment area corresponding to the particle animation element are displayed in the virtual scene. After the user triggers the parameter adjustment operation in the parameter adjustment area, the computer device plays the particle animation corresponding to the particle animation element based on the parameter adjustment operation. In other words, the parameter adjustment process of the particle animation element is visualized through the parameter adjustment area, so that the user can freely adjust the display parameter of the particle animation element. On the one hand, selection requirements of different users for the particle animation can be satisfied. On the other hand, a computer can be prevented from preselecting and setting a plurality of styles of particle animation elements for storage, thereby reducing data storage overheads of a computer.

In this embodiment, a selection operation is performed on a parameter type option, so as to perform a parameter adjustment operation in an adjustment area corresponding to the parameter type option, so that the user can centrally adjust display parameters of the same parameter type, thereby improving efficiency of parameter adjustment.

In this embodiment, when the parameter type option is implemented as an appearance type option, the particle animation element is divided into a plurality of element display parts, thereby implementing appearance parameter adjustment of different element display parts, and enhancing diversity of the appearance parameter adjustment.

In this embodiment, a key frame in an adjustment sub-area is selected, and a color adjustment operation is performed on a first display part, so that the display parameter of the particle animation element in the virtual scene can be further refined, thereby increasing adjustment types of parameter adjustment.

In this embodiment, through a key frame addition operation, a quantity of color changes of the particle animation element during the display of the particle animation can be increased, and color change rules are implemented through the key frame addition operation triggered by the user, thereby enriching the display mode of the particle animation, and causing the color changes of the generated particle animation to be more diverse.

In this embodiment, a key frame color array is generated based on the playback position of the candidate key frame in the particle animation and the color parameter, so that storage security and orderliness of the color display parameter of the particle animation element can be improved, and display accuracy of the particle animation can be enhanced, thereby avoiding loss or an error of color information during the playback of the particle animation. Moreover, through the ordered key frame color array, logicality and coherence of the color changes of the particle animation can be enhanced, thereby ensuring fluency and a visual effect of the generated particle animation.

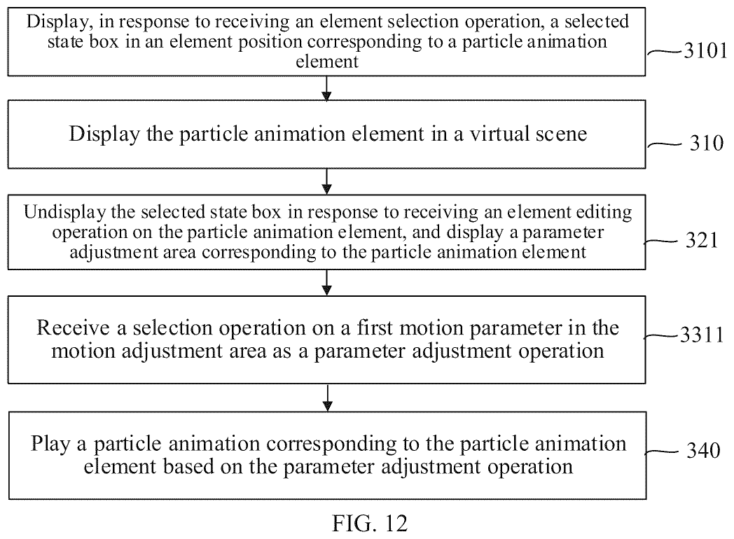

In some embodiments, the parameter adjustment operation for the motion type parameter is described in detail. Exemplarily, FIG. 12 shows a flowchart of a method for displaying a particle animation according to an exemplary embodiment of this application. To be specific, before operation 310, the method further includes operation 3101, operation 320 further includes operation 321, and operation 330 further includes operation 3311. As shown in FIG. 12, the method includes the following operations.

Operation 3101: Display, in response to receiving an element selection operation, a selected state box in an element position corresponding to the particle animation element.

Exemplarily, the element selection operation is configured for determining the particle animation element for adjustment of a display parameter.

In some embodiments, the selected state box is configured for indicating that the particle animation element is currently in a selected state.

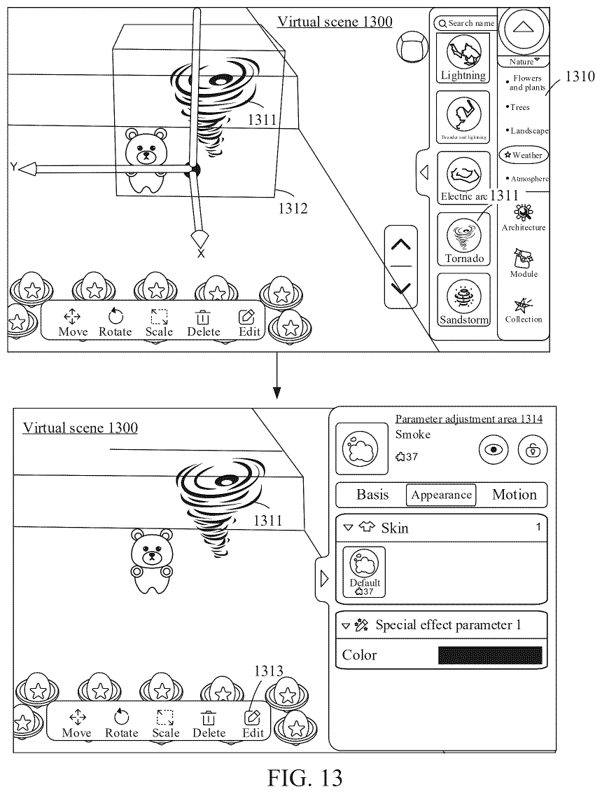

Exemplarily, FIG. 13 is a schematic diagram showing a selected state box according to an exemplary embodiment of this application. As shown in FIG. 13, a virtual scene 1300 is currently displayed. The virtual scene 1300 includes an element selection area 1310. The element selection area 1310 includes a plurality of particle elements. When a selection operation on a particle animation element 1311 (a tornado) is received in the element selection area 1310, the selection operation is used as the element selection operation. The particle animation element 1311 is displayed in the virtual scene 1300, and a selected state box 1312 is displayed in a position of the particle animation element 1311.

Operation 321: Undisplay the selected state box in response to receiving an element editing operation on the particle animation element, and display a parameter adjustment area corresponding to the particle animation element.

Exemplarily, the element editing operation is configured for indicating a determination to adjust the display parameter of the particle animation element.

As shown in FIG. 13, an edit control 1313 is displayed in the virtual scene 1300. When a trigger operation on the edit control 1313 is received, the selected state box 1312 is undisplayed, and a parameter adjustment area 1314 corresponding to the particle animation 1311 is displayed.

Operation 3311: Receive a selection operation on a first motion parameter in the motion adjustment area as the parameter adjustment operation.

The parameter type option includes a motion type option, and the adjustment area includes a motion adjustment area.

Exemplarily, the parameter type option further includes the motion type option. The motion type option is configured for adjusting a motion parameter corresponding to the particle animation element during playback of the particle animation in the virtual scene. Therefore, the motion adjustment area includes a plurality of candidate motion parameters.

In some embodiments, the motion type option includes a plurality of candidate motion parameters, which are described in detail below. 1. Motion unit mode: full range of motion mode, single-trip displacement mode, cyclic reciprocation displacement, single-trip rotation mode, oscillating motion mode, and way point motion mode; 2. Motion cycle form: single-trip motion, continuous single trip, and cyclic reciprocation; 3. Motion start signal: After receiving a signal, a motion unit switches to an active state. If an activation signal is empty, after a virtual activity starts, the activity unit is in an active state by default; otherwise, it is considered that the activity unit is in a suspended state. 4. Motion stop signal: After receiving the signal, the motion unit switches to a suspended state. In the suspended state, a display duration of a particle animation is not counted. 5. Motion return signal: Configuration is performed in a single-trip motion form. After signal excitation is received, a reverse motion is performed. 6. Whether to perform duration management: After duration management is enabled, a display duration is exposed for configuration. When the duration management is disabled, the display duration is unlimited by default. 7. Motion mode: linear motion and rotational motion. 8. Based on a world coordinate system: When a local coordinate system is selected, a motion direction changes with a rotation direction. Except for the full range of motion mode, the remaining motion modes all refer to the local coordinate system. 9. Initial delay time: During display of a virtual scene, a particle animation element starts to move only after being delayed for some time. 10. Single-trip motion time: It refers to a single-trip motion duration. 11. Pause time after arrival: It refers to a time a particle animation element pauses after reaching the target position before performing subsequent motion. 12. Pause time after return: It refers to a time the particle animation element pauses after returning to the starting position before performing subsequent motion. 13. velocity type: uniform, acceleration, deceleration, smooth, and oscillation. 14. Sub-direction velocity: X-direction velocity: a velocity of motion along an X-axis (in meter per second); Y-direction velocity; a velocity of motion along a Y-axis (in meter per second); and Z-direction velocity: a velocity of motion along a Z-axis (in meter per second). 15. Sub-direction angular velocity: X-direction angular velocity: an angular velocity along the X-axis (in degree per second); Y-direction angular velocity: an angular velocity along the Y-axis (in degree per second); and Z-direction angular velocity: an angular velocity along the Z-axis (in degree per second).

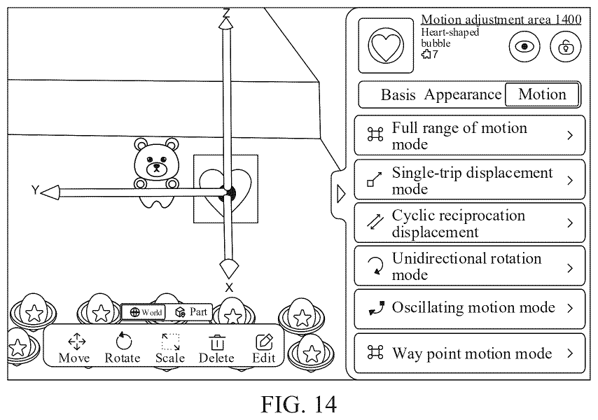

Exemplarily, FIG. 14 is a schematic diagram showing a motion adjustment area according to an exemplary embodiment of this application. As shown in FIG. 14, a motion adjustment area 1400 corresponding to a particle element animation is currently displayed. The motion adjustment area 1400 includes a plurality of candidate motion unit modes: a full range of motion mode, a single-trip displacement mode, a cyclic reciprocation displacement mode, a unidirectional rotation mode, an oscillating motion mode, and a way point motion mode.

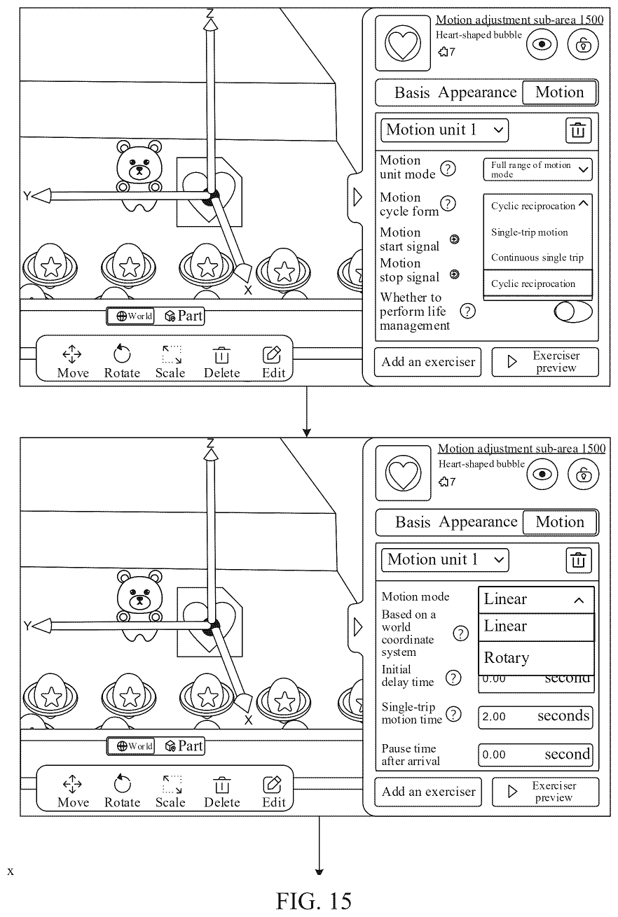

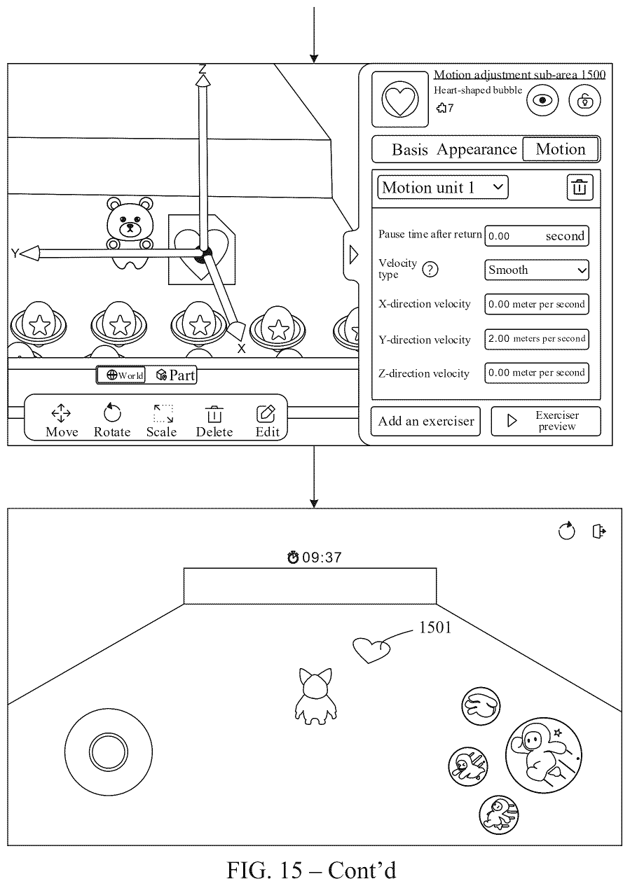

When a selection operation on the full range of motion mode is received, as shown in FIG. 15, a motion adjustment sub-area 1500 corresponding to the full range of motion mode is currently displayed. The motion unit mode is set to the full range of motion mode, the motion cycle form is set to cyclic reciprocation, the motion mode is set to linear, the one-way motion time is 2 meters per second, the velocity type is smooth, and the Z-direction velocity is 2 meters per second. Therefore, the final particle animation is displayed as a particle animation element 1501 performing a smooth reciprocating motion along the Z-axis.

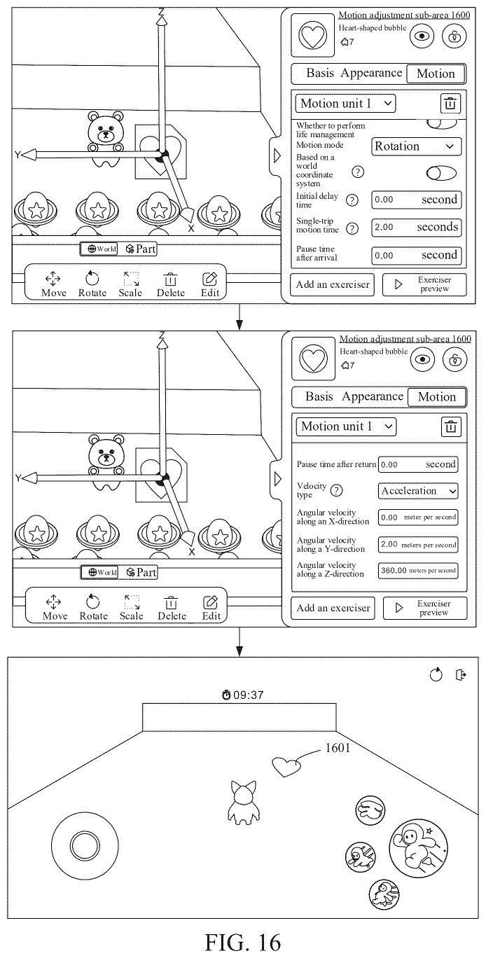

As shown in FIG. 16, if rotation is selected as the motion mode in a motion adjustment sub-area 1600, the velocity type is acceleration, and the Z-direction angular velocity is 360 degrees/second, the final particle animation is displayed as a particle animation element 1601 performing a 360-degree circular rotation motion around the Z-axis.

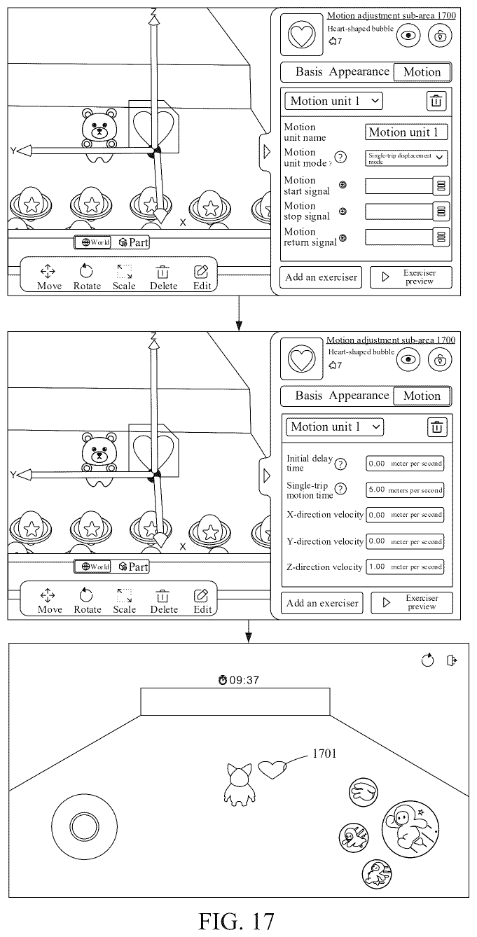

When a selection operation on the single-trip displacement mode is received, as shown in FIG. 17, a motion adjustment sub-area 1700 corresponding to the single-trip displacement mode is currently displayed. The motion unit mode is set to the single-trip displacement mode, the single-trip motion time is set to 5 seconds, and the Z-direction velocity is 1 meter per second. Therefore, the final particle animation is displayed as a particle animation element 1701 displacing upward for a period of time and then stopping the motion.

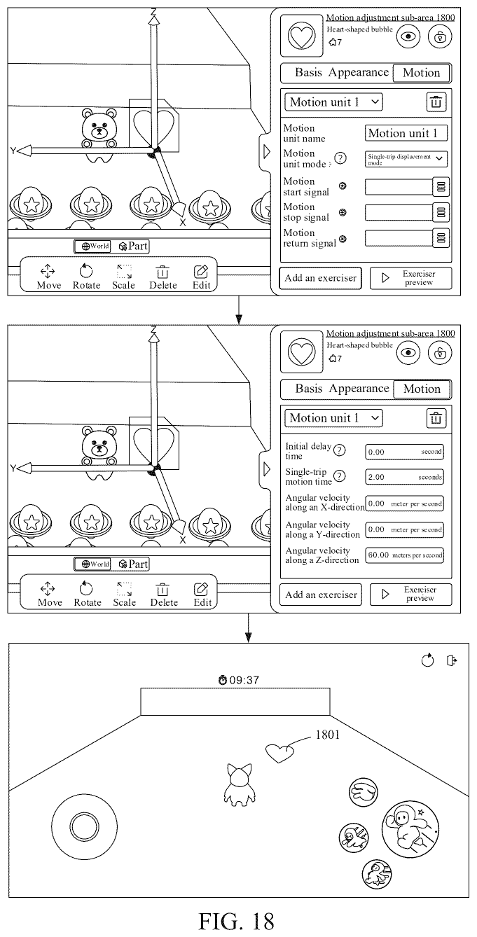

When a selection operation on the unidirectional rotation mode is received, as shown in FIG. 18, a motion adjustment sub-area 1800 corresponding to the unidirectional rotation mode is currently displayed. The motion unit mode is set to the unidirectional rotation mode, the single-trip motion time is set to 2 seconds, and the Z-direction angular velocity is set to 60 degrees per second. Therefore, the final particle animation is displayed as a particle animation element 1801 rotating along the Z-axis by a certain angle and then stopping the motion.

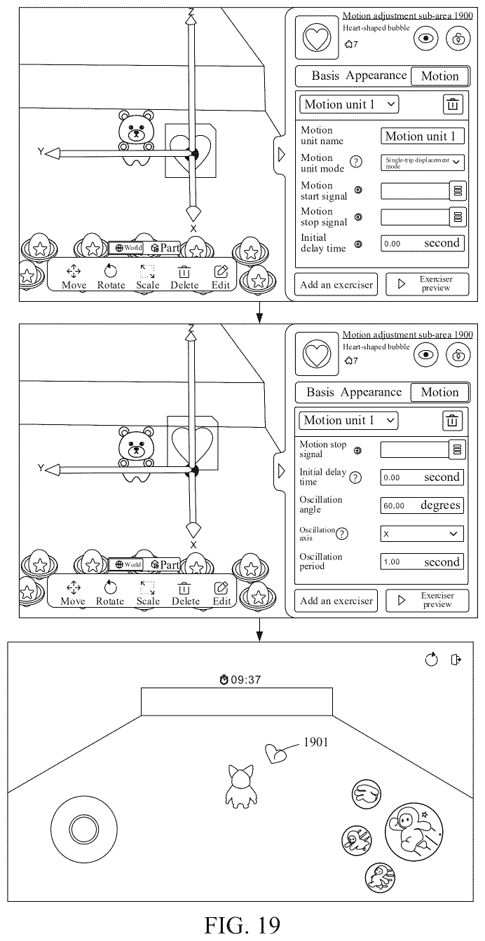

When a selection operation on the oscillation motion mode is received, as shown in FIG. 19, a motion adjustment sub-area 1900 corresponding to the oscillation motion mode is currently displayed. The motion unit mode is set to the oscillation motion mode, the oscillation angle is 60 degrees, and the oscillation period is 1 second. Therefore, the final particle animation is displayed as a particle animation element 1901 swinging left and right within a certain angle.

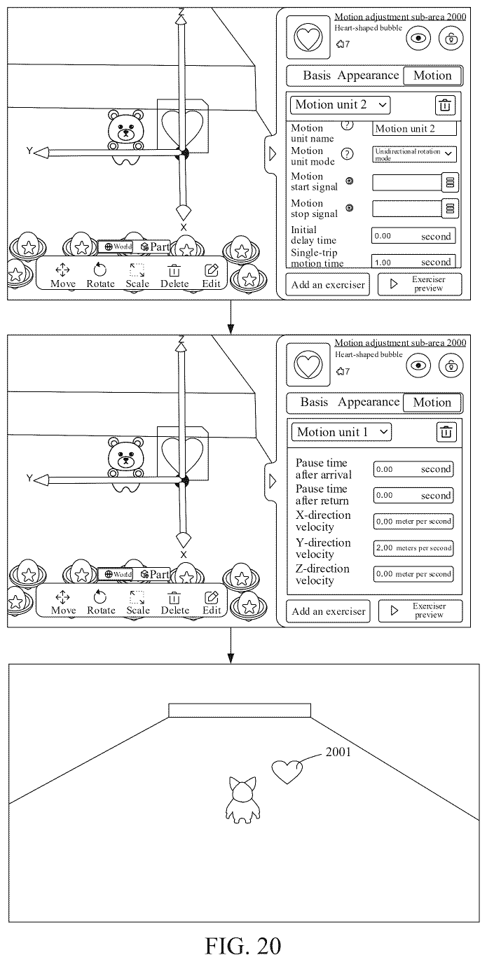

When a selection operation on the cyclic reciprocation displacement is received, as shown in FIG. 20, a motion adjustment sub-area 2000 corresponding to the cyclic reciprocation displacement is currently displayed. The motion unit mode is selected as the cyclic reciprocation displacement, the single-trip motion time is 1 second, and the Z-direction velocity is 1 meter per second. Therefore, the final particle animation is displayed as a particle animation element 2001 moving up and down along the Z-axis.

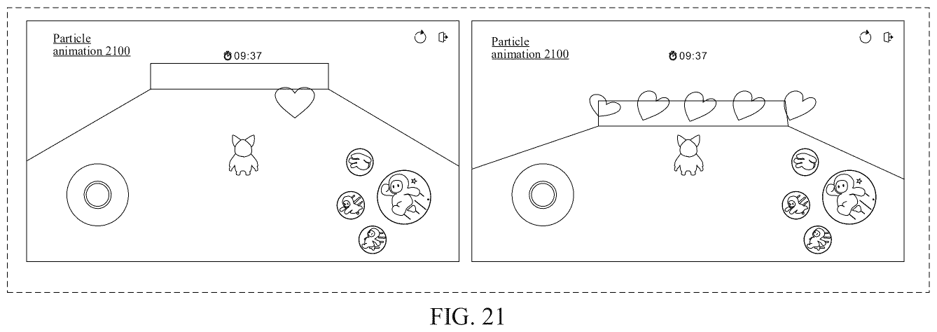

Exemplarily, the motion unit mode may be superimposed and displayed. FIG. 21 is a schematic diagram showing superimposed display of motion unit modes according to an exemplary embodiment of this application. As shown in FIG. 21, a particle animation 2100 is currently displayed. When two motion unit modes, namely, the oscillation motion mode and the cyclic reciprocation displacement, are superimposed and run, the particle animation is more vivid due to interference of the two effects. When more particle animation elements are duplicated, the duplicated particle animation elements inherit all motion parameter effects.

Exemplarily, the way point motion mode is described in detail. A way point refers to a key point along a movement path when a particle animation element moves in a virtual scene. When the way point motion mode is selected, a first motion parameter in the way point motion mode is a motion position parameter, which is configured for indicating a display position (i.e., a key point position) of the particle animation element during playback of the particle animation in the virtual scene. When a selection operation on the motion position parameter is received in the motion adjustment sub-area in the way point motion mode, a position editing sub-area corresponding to the display position is displayed, which is configured to determine a plurality of display positions in the position editing sub-area. To be specific, the first motion parameter includes the motion position parameter. The motion position parameter is configured for indicating the display position of the particle animation element in the virtual scene. When a selection operation on the motion position parameter is received in the motion adjustment area, the position editing sub-area corresponding to the motion position parameter is displayed. A position setting operation is received in the position editing sub-area as the parameter adjustment operation, the position setting operation being configured for setting at least one of parameters such as a starting position, an ending position, a dwell position, a dwell time, and a display mode corresponding to the particle animation element in the virtual scene.

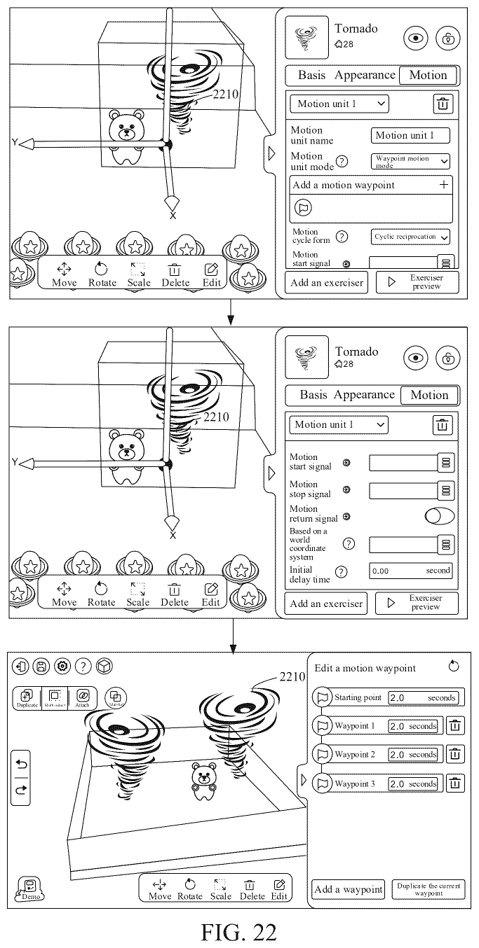

Exemplarily, FIG. 22 is a schematic diagram of a way point motion mode according to an exemplary embodiment of this application. As shown in FIG. 22, a particle animation element 2210 is dragged into a virtual scene. A motion unit mode is set to a way point motion mode, and the motion cycle form is set to cyclic reciprocation. By clicking to add a motion way point on a motion way point editing interface, a way point may be added or deleted as required, and time between way points may be set. Each way point can further be set with A position, rotation, and scaling to display the particle animation. In this way, the particle animation is implemented by the particle animation element 2210 performing a cyclic reciprocation motion based on the set way point positions, with an element size thereof also gradually changes.

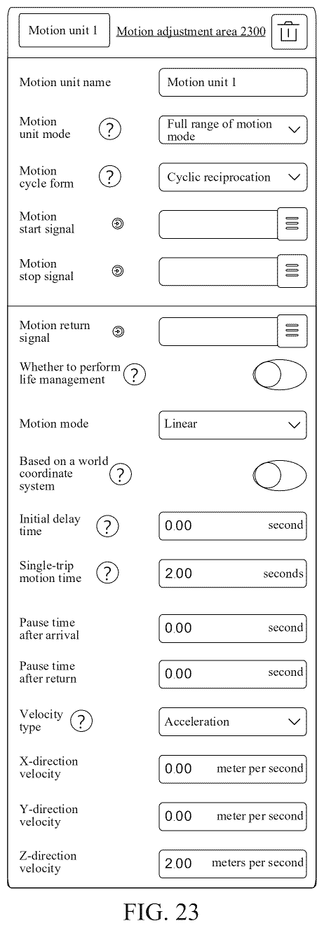

Exemplarily, the process of adjusting the motion parameters under the motion type option includes a plurality of parameter adjustment manners such as setting a specific numerical value of the motion parameter and determining the first motion parameter from a plurality of candidate motion parameters. Exemplarily, FIG. 23 is a schematic diagram showing a manner of adjusting a motion parameter according to an exemplary embodiment of this application. As shown in FIG. 23, a motion adjustment area 2300 is currently displayed, which includes a plurality of types of motion parameters from the foregoing embodiments for a user to select, so that it can be ensured that the motion mode of the finally displayed particle animation meets user requirements.

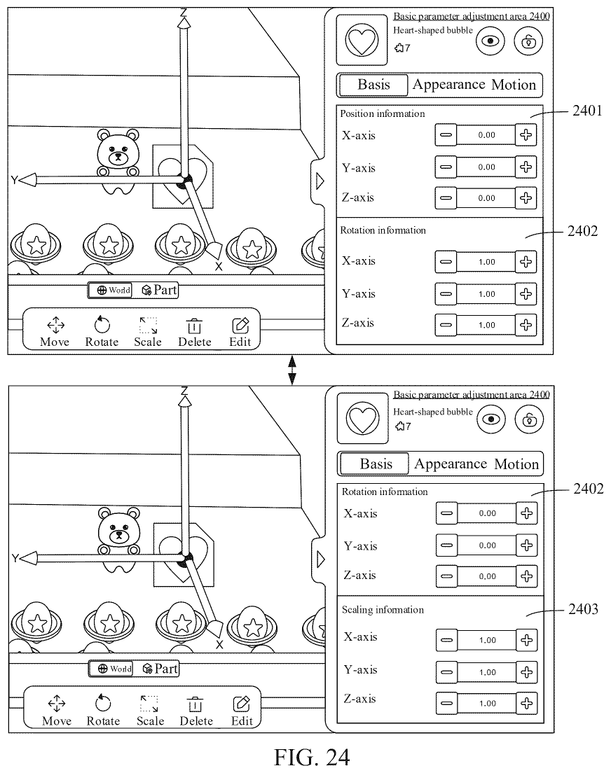

Exemplarily, in addition to the appearance type option and the motion type option described above, the parameter type option further includes a basic type option, which is configured to set a specific parameter for movement, rotation, and scaling of the particle animation in each axial direction (the X-axis, the Y-axis, and the Z-axis). Exemplarily, FIG. 24 is a schematic diagram showing adjustment of a basic parameter according to an exemplary embodiment of this application. As shown in FIG. 24, when the parameter type option includes the basic type option, a basic parameter adjustment area 2400 is displayed, including a position sub-area 2401, a rotation sub-area 2402, and a scaling sub-area 2403, which are configured to adjust parameters for movement, rotation, and scaling of the particle animation in each axial direction.

Based on the above, according to the method for displaying a particle animation provided in the embodiments of this application, when the master account has edit permission of the virtual scene, the particle animation element and the parameter adjustment area corresponding to the particle animation element are displayed in the virtual scene. After the user triggers the parameter adjustment operation in the parameter adjustment area, the computer device plays the particle animation corresponding to the particle animation element based on the parameter adjustment operation. In other words, the parameter adjustment process of the particle animation element is visualized through the parameter adjustment area, so that the user can freely adjust the display parameter of the particle animation element. On the one hand, selection requirements of different users for the particle animation can be satisfied. On the other hand, a computer can be prevented from preselecting and setting a plurality of styles of particle animation elements for storage, thereby reducing data storage overheads of a computer.

In this embodiment, when the parameter type option is implemented as the motion type option, a selection operation is performed on the first motion parameter in the motion adjustment area to adjust the motion parameter, so as to ensured that the motion mode of the particle element animation during the playback of the final particle animation meets the user requirement, thereby improving user experience when the user customizes the particle animation.

In this embodiment, a selection operation is performed on the motion position parameter, so that the motion mode of the particle animation element in the particle animation can be more diverse.

In this embodiment, a selected state box is displayed when a particle animation element for parameter adjustment is selected, and the selected state box is undisplayed during the parameter adjustment, so that the selected state box can be configured for indicating the particle animation element for performing parameter adjustment is selected and determined, thereby ensuring the accuracy of selecting the particle animation element. In addition, the selected state box is undisplayed during the adjustment, so that the user views the adjusted particle animation more visually and clearly, thereby improving clarity of an animation adjustment result that is shown.

Exemplarily, a description is provided by using an example in which the method for displaying a particle animation according to this application is applied to a scenario of a puzzle game. Exemplarily, FIG. 25 is a schematic diagram showing a method for displaying a particle animation according to an exemplary embodiment of this application. As shown in FIG. 25, a virtual scene 2500 is currently displayed. When a user controls a master virtual object 2550 to perform a scene activity in the virtual scene 2500, a particle animation element 2501 is dragged from an animation element library 2510 into the virtual scene 2500 for display. Furthermore, through various display parameters under the three different parameter type options, i.e., a basic adjustment area 2520, an appearance adjustment area 2530, and a motion adjustment area 2540, the display parameter of the particle animation is adjusted. Finally, an adjusted particle animation 2560 is displayed in the virtual scene 2500.

Through the method provided in the embodiments of this application, a concept of “life cycle” is added, and an editing manner of a graphical interface and a manner of splitting sub-effects are provided, so that the player may adjust various parameters of special effects for various parts of the special effects during the life cycle. A concept of a motion parameter is added, so that the player can conveniently and quickly adjust a motion trajectory of the special effect in the world, thereby directing some animation effects.

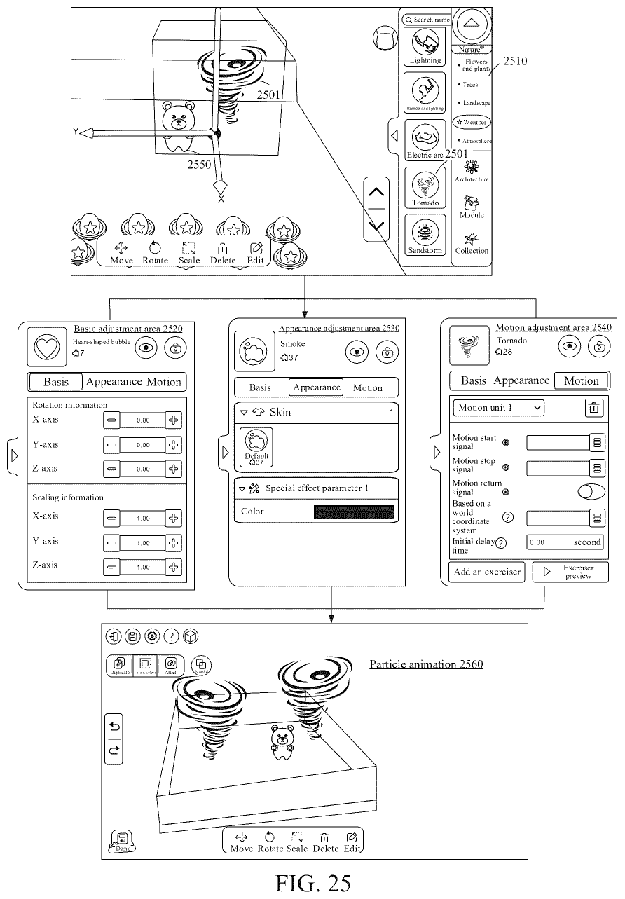

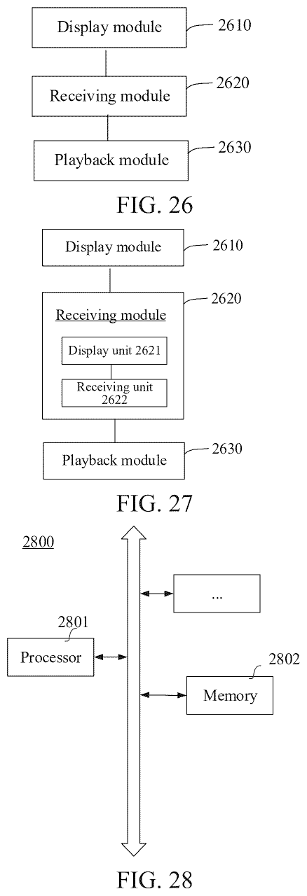

FIG. 26 is a structural block diagram of an apparatus for displaying a particle animation according to an exemplary embodiment of this application. As shown in FIG. 26, the apparatus includes the following parts:
a display module 2610, configured to display a particle animation element in a virtual scene, the virtual scene including a master virtual object controlled by a master account, the master account having edit permission for the virtual scene, and the master virtual object being configured to be controlled to participate in a scene activity in the virtual scene;
the display module 2610 being further configured to display a parameter adjustment area corresponding to the particle animation element, the parameter adjustment area including a plurality of display parameters corresponding to the particle animation element;
a receiving module 2620, configured to receive a parameter adjustment operation in the parameter adjustment area, the parameter adjustment operation being configured for indicating adjustment of the display parameter of the particle animation element in a picture of the virtual scene; and
a playback module 2630, configured to play a particle animation corresponding to the particle animation element based on the parameter adjustment operation.

In some embodiments, the parameter adjustment area includes a plurality of parameter type options. As shown in FIG. 27, the receiving module 2620 includes:
a display unit 2621, configured to display, in response to receiving a selection operation on each of the parameter type options in the parameter adjustment area, an adjustment area corresponding to the parameter type option, the adjustment area including a plurality of adjustment parameter contents under the parameter type option; and
a receiving unit 2622, configured to receive the parameter adjustment operation in the adjustment area.

In some embodiments, the parameter type options include an appearance type option, the adjustment area includes an appearance adjustment area, the appearance adjustment area includes a plurality of candidate position options, and each of the candidate position options is configured for indicating an element display part of the particle animation element during the display.

The receiving unit 2622 is further configured to: display, in response to receiving a selection operation on a first position option among the plurality of candidate position options in the appearance adjustment area, an adjustment sub-area corresponding to the first position option, the adjustment sub-area including a plurality of parameter content options; and receive an adjustment operation on the parameter content option in the adjustment sub-area as the parameter adjustment operation.

In some embodiments, the first position option corresponds to a first display part, the first display part corresponding to a first color.

The receiving unit 2622 is further configured to: display, in response to receiving a selection operation on a first key frame in the adjustment sub-area, a color adjustment sub-interface corresponding to the first key frame, the first key frame being configured for indicating a display moment of a first display part of the particle animation element during playback of the particle animation; and receive a color adjustment operation in the color adjustment sub-interface as the parameter adjustment operation, the color adjustment operation being configured for indicating adjustment of the first color corresponding to the first display part to a second color at the first key frame.

In some embodiments, the display unit 2621 is configured to display, in response to receiving a key frame addition operation in the adjustment sub-area, a color adjustment sub-interface corresponding to a second key frame, the key frame addition operation being configured for indicating addition of the second key frame.

In some embodiments, the adjustment sub-area includes a plurality of candidate key frames.

The display unit 2621 is configured to: obtain a playback position of the plurality of candidate key frames in the particle animation; obtain a color parameter corresponding to each of the plurality of candidate key frames based on the color adjustment operation; and generate a key frame color array based on the playback positions of the plurality of candidate key frames in the particle animation and the color parameter.

In some embodiments, the display unit 2621 is further configured to: read the key frame color array, and determine a color parameter corresponding to each of the plurality of candidate key frames; traverse the plurality of candidate key frames to obtain an arrangement order corresponding to the plurality of candidate key frames; perform, based on a color parameter corresponding to each of two adjacent candidate key frames among the plurality of candidate key frames, a color interpolation operation on the two adjacent candidate key frames to obtain a color change corresponding to the particle animation; and display the particle animation based on playback positions of the plurality of candidate key frames in the particle animation and the color change.

In some embodiments, the parameter type option includes a motion type option, and the adjustment area includes a motion adjustment area.

The receiving module 2620 is further configured to receive a selection operation on a first motion parameter in the motion adjustment area as the parameter adjustment operation.

In some embodiments, the first motion parameter includes a motion position parameter, the motion position parameter being configured for indicating a display position of the particle animation element in the virtual scene.

The receiving module 2620 is further configured to: receive a selection operation on the motion position parameter in the motion adjustment area, and display a position editing sub-area corresponding to the motion position parameter; and receive a position setting operation in the position editing sub-area as the parameter adjustment operation, the position setting operation being configured for setting at least one of parameters such as a starting position, an ending position, a dwell position, a dwell time, and a display mode corresponding to the particle animation element in the virtual scene.

In some embodiments, the display module 2610 is further configured to display, in response to receiving the element selection operation, a selected state box at an element position corresponding to the particle animation element; and undisplay the selected state box in response to receiving an element editing operation on the particle animation element, and display a parameter adjustment area corresponding to the particle animation element.

In some embodiments, the display module 2610 is further configured to receive a template generation operation. The template operation is configured to generate a display template based on the adjusted display parameter; and display, in response to receiving a selection operation on a first animation element, the first animation element in the virtual scene based on the display template, the first animation element being different from the particle animation element.

In some embodiments, the display module 2610 is further configured to display, in response to receiving a long-press operation on the particle animation element in the virtual scene, and an operation duration reaching a preset duration threshold, a parameter introduction area in an element position corresponding to the particle animation element, the parameter introduction area including the adjusted display parameter.

For the apparatus for displaying a particle animation provided in the foregoing embodiments, only division of the foregoing functional modules is described by using examples. In practical application, the foregoing functions may be completed by different functional modules as required. To be specific, an internal structure of the device is divided into different functional modules to complete all or part of the functions described above. In addition, the embodiments of the apparatus for displaying a particle animation and the method for displaying a particle animation provided in the foregoing embodiments belong to the same concept. For a specific implementation process thereof, reference is made to the method embodiment. Details are not described herein again.

FIG. 28 is a structural block diagram of a terminal 2800 according to an exemplary embodiment of this application. The terminal 2800 may be a smartphone, a tablet computer, an MP3 player, an MP4 player, a notebook computer, or a desktop computer. The terminal 2800 may further be referred to as another name such as user equipment, a portable terminal, a laptop terminal, or a desktop terminal.

Generally, the terminal 2800 includes a processor 2801 and a memory 2802.

The processor 2801 may include one or more processing cores, for example, a 4-core processor and an 8-core processor. The processor 2801 may be implemented by using at least one of the following hardware forms: a digital signal processor (DSP), a field-programmable gate array (FPGA), and a programmable logic array (PLA). The processor 2801 may alternatively include a main processor and a coprocessor. The main processor is a processor configured to process data in a wake-up state, and is also referred to as a central processing unit (CPU). The coprocessor is a low power consumption processor configured to process data in a standby state. In some embodiments, the processor 2801 may have a graphics processing unit (GPU) integrated therein. The GPU is configured to render and draw content that needs to be displayed on a display screen. In some embodiments, the processor 2801 may further include an AI processor. The AI processor is configured to process computing operations related to machine learning.

The memory 2802 may include one or more computer-readable storage media. The computer-readable storage medium may be non-transient. In some embodiments, the non-transitory computer-readable storage medium in the memory 2802 is configured to store at least one instruction. The at least one instruction is configured for being executed by the processor 2801 to implement the method for displaying a message provided in the method embodiment of this application.

In some embodiments, the terminal 2800 further includes another component. A person skilled in the art may understand that the structure shown in FIG. 28 does not constitute a limitation on the terminal 2800. The terminal may include more or fewer components than those shown in the figure, or some merged components, or different component arrangements.

A person of ordinary skill in the art may understand that all or some of the operations of the methods in the above embodiments may be implemented by instructing relevant hardware through a program. The program may be stored in a non-transitory computer-readable storage medium. The computer-readable storage medium may be the computer-readable storage medium included in the memory in the foregoing embodiment, or may be a non-transitory computer-readable storage medium that exists alone and is not installed in the terminal. The computer-readable storage medium has at least one instruction, at least one program, a code set, or an instruction set stored therein, the at least one instruction, the at least one program, the code set, or the instruction set being loaded and executed by a processor to implement the method for displaying a particle animation according to any one of the foregoing embodiments.

A person of ordinary skill in the art may understand that all or part of the operations of implementing the foregoing embodiments may be implemented by hardware, or may be implemented by a program instructing related hardware. The program may be stored in a non-transitory computer-readable storage medium. The storage medium mentioned above may be a read-only memory, a magnetic disk, an optical disc, or the like.

The above descriptions are merely exemplary embodiments of this application, and are not intended to limit this application. Any modification, equivalent replacement, or improvement made within the spirit and principle of this application falls within the protection scope of this application.

What is claimed is:

1. A method for generating a particle animation, performed by a computer device, the method comprising:
displaying a particle animation element in a virtual scene;
displaying a parameter adjustment area corresponding to the particle animation element in the virtual scene, the parameter adjustment area comprising a display parameter corresponding to the particle animation element;
receiving a parameter adjustment operation in the parameter adjustment area; and
generating and playing, in the virtual scene, a particle animation corresponding to the particle animation element based on the parameter adjustment operation.

2. The method according to claim 1, wherein the parameter adjustment area comprises a plurality of parameter type options; and the method further comprises:
displaying, in response to receiving a selection operation on each of the parameter type options in the parameter adjustment area, an adjustment area corresponding to the parameter type option, the adjustment area comprising a plurality of adjustment parameter contents under the parameter type option; and
receiving the parameter adjustment operation in the adjustment area.

3. The method according to claim 2, wherein the parameter type options comprise an appearance type option, the adjustment area comprises an appearance adjustment area, the appearance adjustment area comprises a plurality of candidate position options, and the candidate position option is configured for indicating an element display part of the particle animation element during the display; and
the receiving a parameter adjustment operation in the parameter adjustment area comprises:
displaying, in response to receiving a selection operation on a first position option among the plurality of candidate position options in the appearance adjustment area, an adjustment sub-area corresponding to the first position option, the adjustment sub-area comprising a plurality of parameter content options; and
receiving an adjustment operation on the parameter content option in the adjustment sub-area as the parameter adjustment operation.

4. The method according to claim 1, wherein the generating and playing, in the virtual scene, a particle animation corresponding to the particle animation element based on the parameter adjustment operation comprises:
determining a color parameter corresponding to each of a plurality of candidate key frames in the parameter adjustment area;
traversing the plurality of candidate key frames to obtain an arrangement order corresponding to the plurality of candidate key frames;
performing, based on the color parameter corresponding to each of two adjacent candidate key frames among the plurality of candidate key frames, a color interpolation operation on the two adjacent candidate key frames to obtain a color change corresponding to the particle animation; and
generating and playing, in the virtual scene, the particle animation based on playback positions of the plurality of candidate key frames in the particle animation and the color change.

5. The method according to claim 1, wherein the displaying a parameter adjustment area corresponding to the particle animation element further comprises:
displaying, in response to receiving an element selection operation, a selected state box in an element position corresponding to the particle animation element; and
hiding the selected state box in response to receiving an element editing operation on the particle animation element, and displaying a parameter adjustment area corresponding to the particle animation element.

6. The method according to claim 1, wherein the method further comprises:
receiving a template generation operation, the template generation operation being configured for generating a display template based on the adjusted display parameter; and
displaying, in response to receiving a selection operation on a first animation element, the first animation element in the virtual scene based on the display template, the first animation element being different from the particle animation element.

7. The method according to claim 1, wherein the method further comprises:
displaying, in response to receiving a long-press operation on the particle animation element in the virtual scene, and an operation duration reaching a preset duration threshold, a parameter introduction area in an element position corresponding to the particle animation element, the parameter introduction area comprising the adjusted display parameter.

8. The method according to claim 1, wherein the parameter adjustment operation being configured for indicating adjustment of the display parameter of the particle animation element in a picture of the virtual scene.

9. A computer device, comprising a processor and a memory, the memory having at least one program stored therein, the at least one program, when being loaded and executed by the processor, causing the computer device to implement a method for generating a particle animation including:
displaying a particle animation element in a virtual scene;
displaying a parameter adjustment area corresponding to the particle animation element in the virtual scene, the parameter adjustment area comprising a display parameter corresponding to the particle animation element;
receiving a parameter adjustment operation in the parameter adjustment area; and
generating and playing, in the virtual scene, a particle animation corresponding to the particle animation element based on the parameter adjustment operation.

10. The computer device according to claim 9, wherein the parameter adjustment area comprises a plurality of parameter type options; and the method further comprises:
displaying, in response to receiving a selection operation on each of the parameter type options in the parameter adjustment area, an adjustment area corresponding to the parameter type option, the adjustment area comprising a plurality of adjustment parameter contents under the parameter type option; and
receiving the parameter adjustment operation in the adjustment area.

11. The computer device according to claim 10, wherein the parameter type options comprise an appearance type option, the adjustment area comprises an appearance adjustment area, the appearance adjustment area comprises a plurality of candidate position options, and the candidate position option is configured for indicating an element display part of the particle animation element during the display; and
the receiving a parameter adjustment operation in the parameter adjustment area comprises:
displaying, in response to receiving a selection operation on a first position option among the plurality of candidate position options in the appearance adjustment area, an adjustment sub-area corresponding to the first position option, the adjustment sub-area comprising a plurality of parameter content options; and
receiving an adjustment operation on the parameter content option in the adjustment sub-area as the parameter adjustment operation.

12. The computer device according to claim 9, wherein the generating and playing, in the virtual scene, a particle animation corresponding to the particle animation element based on the parameter adjustment operation comprises:
determining a color parameter corresponding to each of a plurality of candidate key frames in the parameter adjustment area;
traversing the plurality of candidate key frames to obtain an arrangement order corresponding to the plurality of candidate key frames;
performing, based on the color parameter corresponding to each of two adjacent candidate key frames among the plurality of candidate key frames, a color interpolation operation on the two adjacent candidate key frames to obtain a color change corresponding to the particle animation; and
generating and playing, in the virtual scene, the particle animation based on playback positions of the plurality of candidate key frames in the particle animation and the color change.

13. The computer device according to claim 9, wherein the displaying a parameter adjustment area corresponding to the particle animation element further comprises:
displaying, in response to receiving an element selection operation, a selected state box in an element position corresponding to the particle animation element; and
hiding the selected state box in response to receiving an element editing operation on the particle animation element, and displaying a parameter adjustment area corresponding to the particle animation element.

14. The computer device according to claim 9, wherein the method further comprises:
receiving a template generation operation, the template generation operation being configured for generating a display template based on the adjusted display parameter; and
displaying, in response to receiving a selection operation on a first animation element, the first animation element in the virtual scene based on the display template, the first animation element being different from the particle animation element.

15. The computer device according to claim 9, wherein the method further comprises:
displaying, in response to receiving a long-press operation on the particle animation element in the virtual scene, and an operation duration reaching a preset duration threshold, a parameter introduction area in an element position corresponding to the particle animation element, the parameter introduction area comprising the adjusted display parameter.

16. The computer device according to claim 9, wherein the parameter adjustment operation being configured for indicating adjustment of the display parameter of the particle animation element in a picture of the virtual scene.

17. A non-transitory computer-readable storage medium, having at least one program stored therein, the at least one program, when being loaded and executed by a processor of a computer device, causing the computer device to implement a method for generating a particle animation including:
displaying a particle animation element in a virtual scene;
displaying a parameter adjustment area corresponding to the particle animation element in the virtual scene, the parameter adjustment area comprising a display parameter corresponding to the particle animation element;
receiving a parameter adjustment operation in the parameter adjustment area; and
generating and playing, in the virtual scene, a particle animation corresponding to the particle animation element based on the parameter adjustment operation.

18. The non-transitory computer-readable storage medium according to claim 17, wherein the parameter adjustment area comprises a plurality of parameter type options; and the method further comprises:
displaying, in response to receiving a selection operation on each of the parameter type options in the parameter adjustment area, an adjustment area corresponding to the parameter type option, the adjustment area comprising a plurality of adjustment parameter contents under the parameter type option; and
receiving the parameter adjustment operation in the adjustment area.

19. The non-transitory computer-readable storage medium according to claim 18, wherein the parameter type options comprise an appearance type option, the adjustment area comprises an appearance adjustment area, the appearance adjustment area comprises a plurality of candidate position options, and the candidate position option is configured for indicating an element display part of the particle animation element during the display; and
the receiving a parameter adjustment operation in the parameter adjustment area comprises:
displaying, in response to receiving a selection operation on a first position option among the plurality of candidate position options in the appearance adjustment area, an adjustment sub-area corresponding to the first position option, the adjustment sub-area comprising a plurality of parameter content options; and
receiving an adjustment operation on the parameter content option in the adjustment sub-area as the parameter adjustment operation.

20. The non-transitory computer-readable storage medium according to claim 17, wherein the generating and playing, in the virtual scene, a particle animation corresponding to the particle animation element based on the parameter adjustment operation comprises:
determining a color parameter corresponding to each of a plurality of candidate key frames in the parameter adjustment area;
traversing the plurality of candidate key frames to obtain an arrangement order corresponding to the plurality of candidate key frames;
performing, based on the color parameter corresponding to each of two adjacent candidate key frames among the plurality of candidate key frames, a color interpolation operation on the two adjacent candidate key frames to obtain a color change corresponding to the particle animation; and
generating and playing, in the virtual scene, the particle animation based on playback positions of the plurality of candidate key frames in the particle animation and the color change.
